(19) United States
(12) Patent Application Publication
(10) Pub. No.: US 2007/0013251 A1
(43) Pub. Date: Jan. 18, 2007

(54) PDC motor-generator

(76) Inventor: Zoran Djuric, Niagara Falls (CA)

Correspondence Address: GOWLING, LAFLEUR HENDERSON LLP, ONE MAIN STREET WEST, HAMILTON, ON, L8P 4Z5, CA

(21) Appl. No.: 11/486,099

(22) Filed: Jul. 14, 2006

Related U.S. Application Data
(60) Provisional application No. 60/698,980, filed on Jul. 14, 2005.

(51) Int. Cl. H02K 47/00; H02K 21/12; H02K 31/00

(52) U.S. Cl. 310/113; 310/156.35; 310/178

(57) ABSTRACT

A pulsating direct current (PDC) power machine (motor or generator) including a rotor of non-magnetic material with magnets circumferentially arranged on the rotor, the rotor being mounted on a shaft, and disc stator(s).

### RELATED APPLICATION

This application claims priority from U.S. Provisional Patent Application 60/698,980 filed Jul. 14, 2005.

### FIELD OF THE INVENTION

This invention relates to brushless DC machines (motors or generators).

### BACKGROUND OF THE INVENTION

In a conventional DC generator, current is generated in the rotor is then drawn from the windings through a commutator via brushes. As is well known, rectification of electrical energy at the commutator involves a certain amount of unwanted difficulties. These difficulties are present with conventional DC motors because all windings are on the rotor. When electricity is supplied to the motor, it is supplied via the brushes. The larger the current required, the heavier the rotor coils must be, placing high demands on bearings and the supporting structures. In addition, drawing large currents through a commutator-brush connection increases the likelihood of electric arcs forming as a brush breaks contact with each commutator bar in turn. This limits the usefulness of DC generators to relatively low current applications.

### SUMMARY OF THE INVENTION

This invention provides a DC machine, motor and/or generator, with windings on the stator, in contrast to conventional DC machines where the windings are on the rotor. A machine in accordance with the invention is brushless and does not require any power rectification or commutation. Such a machine is more efficient than conventional DC machines, needs less maintenance and can operate at higher speeds without current limitation.

### BRIEF DESCRIPTION OF THE DRAWINGS

Embodiments of the invention will now be described, by way of example, with reference to the accompanying drawings, in which:

FIG. 1 is a diagrammatic side view of a PDC power motor-generator in accordance with one embodiment of the invention,

FIG. 2 is a side view thereof showing the flux patterns produced in the stator,

FIG. 3.1 is a side view of the stator,

FIG. 3.2 is a plan view thereof,

FIG. 3.3 is a diagrammatic view of the magnetic core edges thereof,

FIG. 4 is a plan view of the stator windings,

FIG. 5.1 is a diagrammatic view of stator windings connected in accordance with an embodiment of the invention,

FIG. 5.2 is a similar view of stator windings connected in accordance with another embodiment of the invention,

FIG. 6 is a side view of the housing,

FIG. 7 is a plan view of the rotor,

FIG. 8.1 is a side view of the shaft,

FIG. 8.2 is a similar view of the fan,

FIG. 8.3 is a front view of the fan,

FIG. 9.1 is a diagrammatic view showing the principle of conventional DC machines,

FIG. 9.2 is a similar view showing the principle of conventional AC machines, and

FIG. 9.3 is a similar view showing the principle of a PDC machine in accordance with the invention.

### DESCRIPTION OF PREFERRED EMBODIMENTS

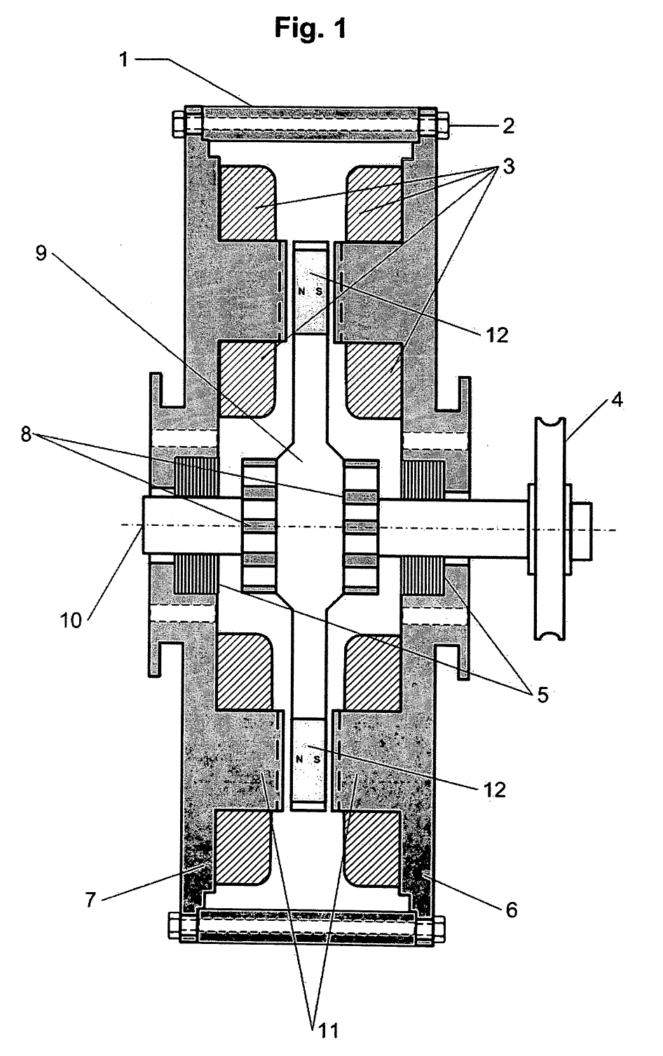

Referring to the drawings, FIG. 1 shows a PDC machine (motor and/or generator) in accordance with one embodiment of the invention and having a base 1 with a stator armature 7 at one end and more stator(s) armatures 6 at the opposite end secured to the chassis 1 via bolts 2. Each stator armature 6,7 has magnetic core edges (in this example 32, but could be more or less), which may each have a magnetic body or a magnetic laminated structure. Stator windings 3 are circumferentially arranged around the magnetic core edges. The windings may be connected in parallel or series depending on required current and/or voltage.

A rotor 9 located between the stators 6,7 is mounted on shaft 10. Magnets 12 are circumferentially mounted on the rotor with all same poles facing the stator 7 and opposed poles facing another stator 6.

If the machine is used as only a motor, then power will be supplied to the stator windings 3, to create a magnetic field at the magnetic core edges opposite to the magnetic field of permanent magnets (or electromagnets) of the rotor 9. The force between the two magnetic fields will cause movement of the rotor, and rotational power will be supplied by the shaft 10 to a pulley 4.

If the machine is used only as a generator, then the shaft 10 will be rotated by rotational power supplied to the pulley 4, causing rotation of the magnets 12 and induction in the stator windings around the magnetic core edges. Cooling fans 8 are mounted on the rotor 9 to pull the stature windings 3.

If the machine is used as a motor and generator, then windings 3A can be used as motor windings and 3B can be used as generator windings at the same time.

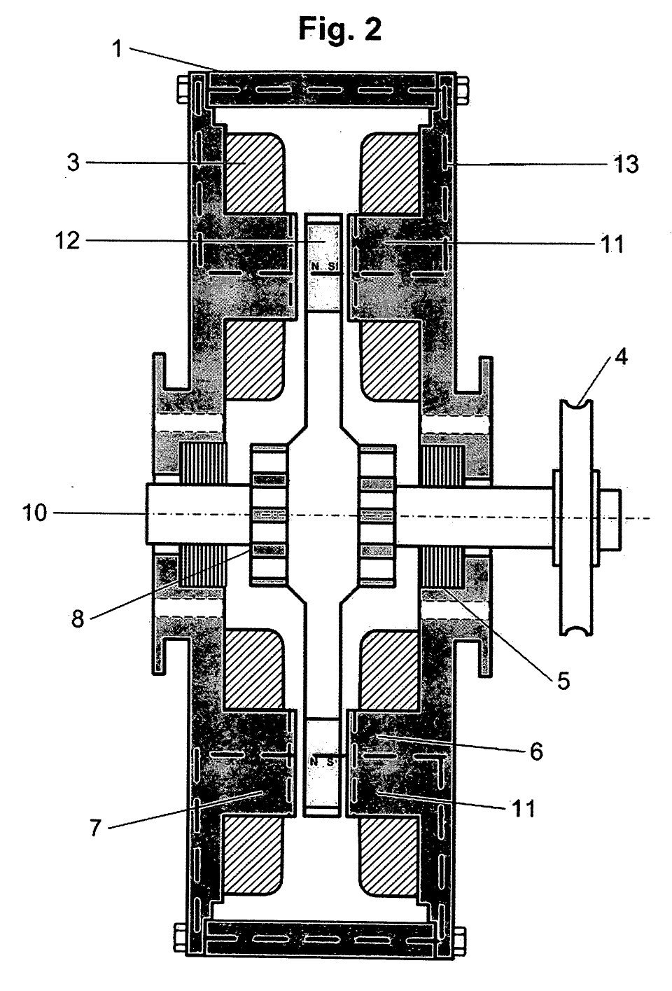

FIG. 2 shows how magnetic flux 13 passes through the armatures of one of the stators 7 and another stator 6 and the chassis 1.

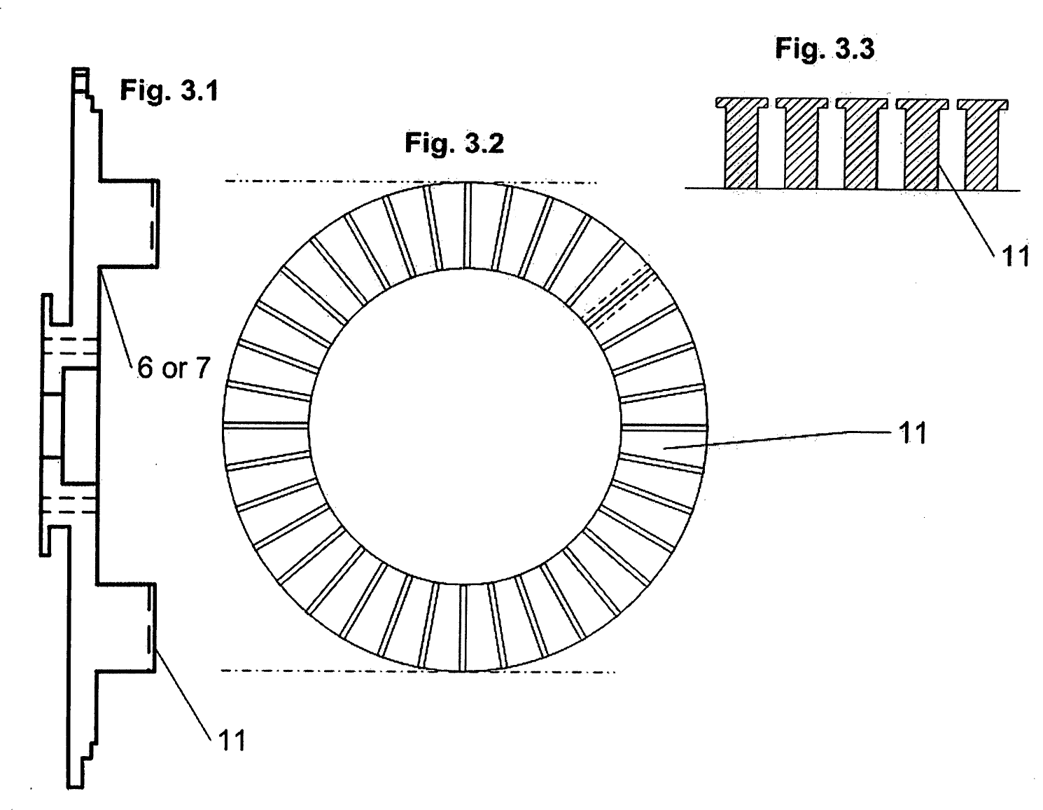

FIGS. 3.1, 3.2 and 3.3 show various details of stator(s), including the magnetic core edges where the stator windings will be located.

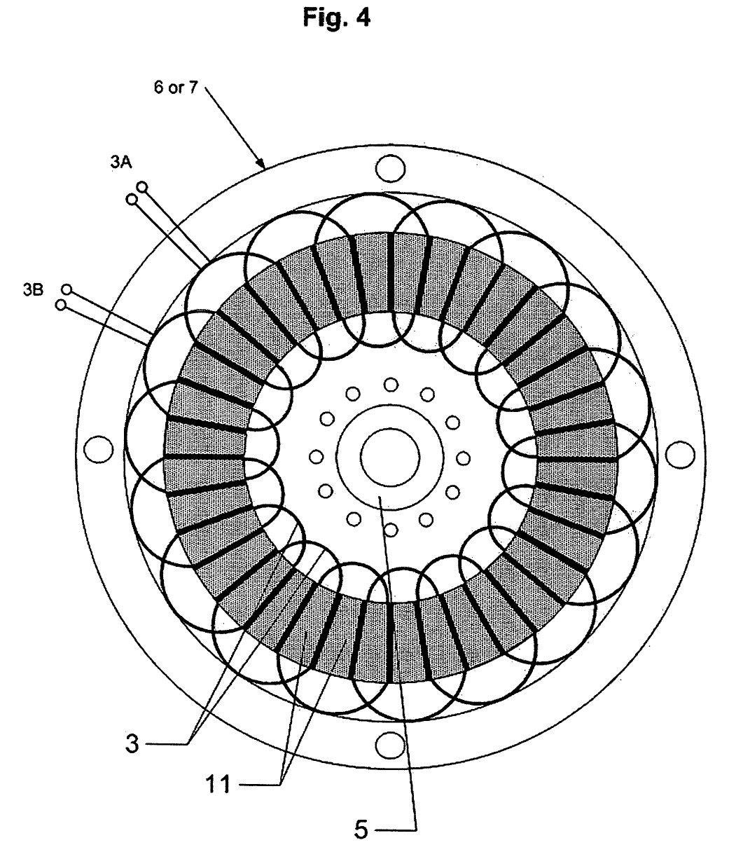

FIG. 4 shows the stator windings around the magnetic core edges facing the front of the magnets on the rotor.

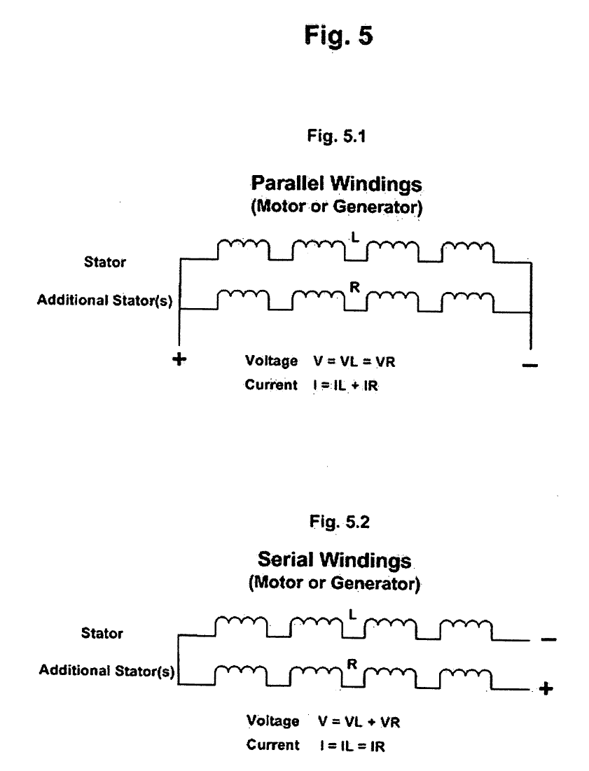

FIGS. 5.1 and 5.2 show two ways in which the stator windings can be connected depending on required voltage and current.

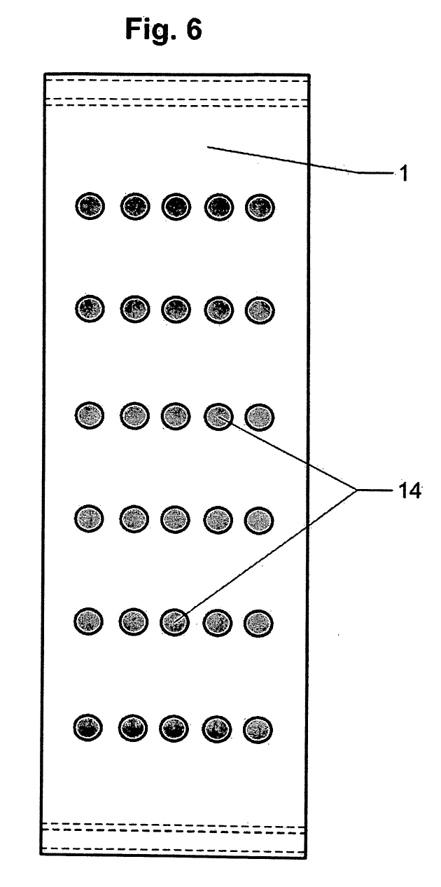

FIG. 6 shows the chassis 1 which has holes 14 around for cooling purposes.

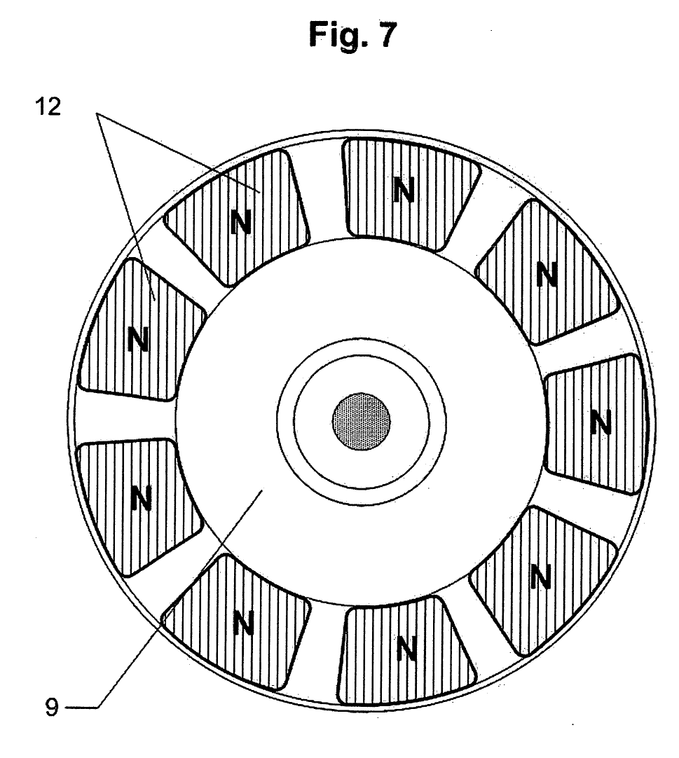

FIG. 7 shows the magnets 12 circumferentially arranged on the rotor 9.

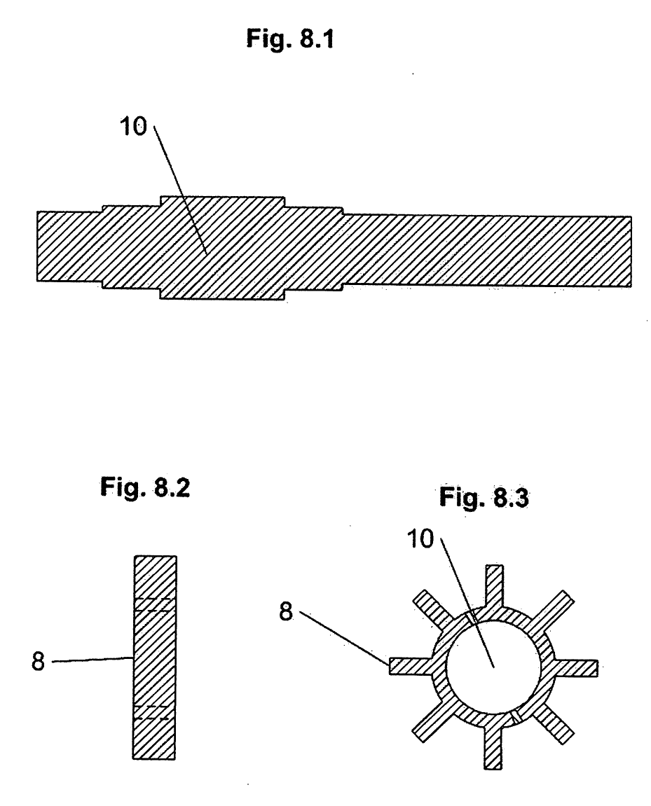

FIGS. 8.1, 8.2 and 8.3 show details of the shaft 10 and cooling holes 8 located on the shaft on each side of the rotor 9.

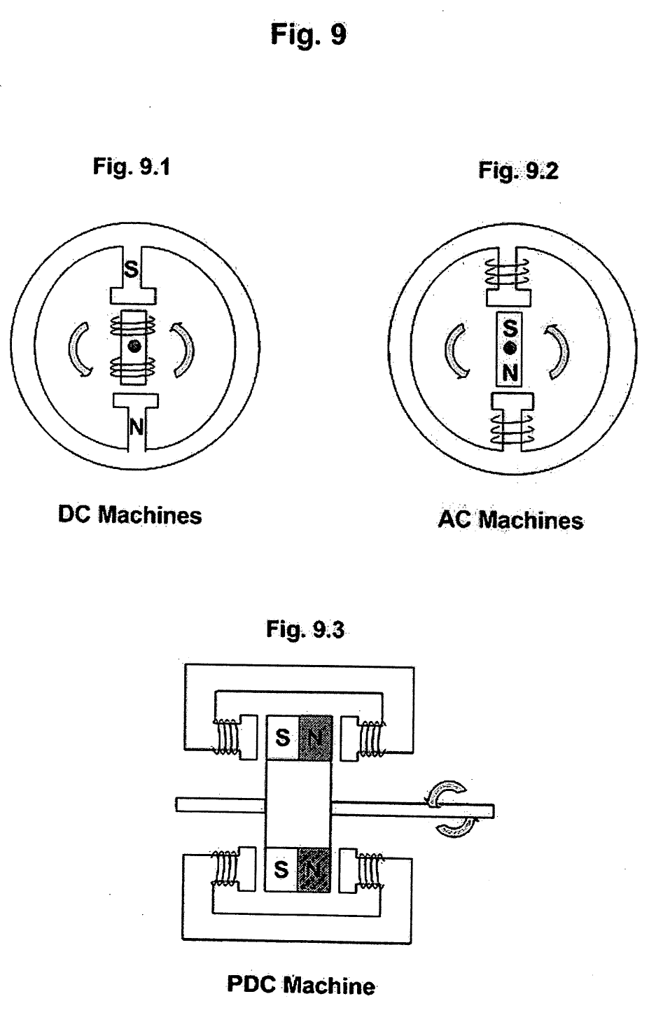

FIGS. 9.1 and 9.2 show the principles of conventional DC and AC machines. As shown in FIG. 9.1, conventional DC machines (motors or generators) have windings on the rotor to produce DC power, such machines require commutators and brushes to get electricity into or out from the rotor. As shown in FIG. 9.2, AC machines have windings on the stator. Such machines do not require commutation to produce AC power. As shown in FIG. 9.3, PDC machines in accordance with the present invention have windings on the stator, similar to AC machines, but produce DC power and do not require commutation and brushes.

It is believed that the advantages of the present invention will be readily apparent to a person skilled in the art from the foregoing description of preferred embodiments. Other embodiments of the invention will also be readily apparent to a person skilled in the art, the scope of the invention being defined in the appended claims.

What is claimed is:

1. A direct current (PDC) power machine (motor and/or generator) including one or more rotor(s) of non-magnetic material with magnets circumferentially arranged on the rotor(s), the rotor(s) being mounted on a shaft without commutation, and one or more stators.

2. A PDC machine as claimed in claim 1 wherein the magnets are permanent magnets.

3. A PDC machine as claimed in claim 1 where the magnets are electromagnets.

4. A PDC machine as claimed in claim 1 wherein the magnets are circumferentially arranged on the rotor.

5. A PDC machine as claimed in claim 1 wherein the same poles of the magnets are arranged to face one of the stator(s).

6. A PDC machine as claimed in claim 1 wherein the rotor is made of non-magnetic material mounted on a shaft without a commutator.

7. A PDC machine as claimed in claim 1 wherein the stators have magnetic core edges each comprising a magnetic body.

8. A PDC machine as claimed in claim 1 wherein the stators have magnetic core edges each comprising a magnetic laminated structure.

9. A PDC machine as claimed in claim 7,8 wherein the stator windings are arranged around the magnetic core edges to function as a motor and/or generator.

10. A PDC machine as claimed in 9 where the stator(s) contain one or more separate windings.

11. A PDC machine as claimed in claim 1 wherein the machine can operate as motor or generator.

12. A PDC machine as claimed in claim 1 wherein the machine can operate as a motor and a generator at the same time.
